(19) United States
(12) Patent Application Publication
(10) Pub. No.: US 2013/0297667 A1
(43) Pub. Date: Nov. 7, 2013

(54) OSBS subtractor Accelerator

(71) Applicant: LESLIE IMRE SOHAY, Bakerfield, CA (US)

(72) Inventor: LESLIE IMRE SOHAY, Bakerfield, CA (US)

(21) Appl. No.: 13/506,637

(22) Filed: May 4, 2012

(51) Int. Cl. G06F 7/50

(52) U.S. Cl. 708/670

(57) ABSTRACT

The OSBS Subtractor Accelerator will enable the subtraction operation to simultaneously subtract all Bits of a data set, where: no ripple affect, no complement operations; therefore no multiple additions, no multiple moves, no temporary storage and no multiple instruction steps are required. In stand alone (pure) format the required time is six propagation delays to perform a subtraction operation. Beside the pure format a distributed or grouped format is available; which is dividing both input operands into groups. This grouped configuration also performs a parallel operation on the bits and on the groups in the same time. However, it needs nine propagation delays to execute a subtraction operation (including the first and second XOR gates); regardless it is a 16, 32 or 64 bit subtractor. It uses considerably less number of components than the pure configuration, and none of the integrated circuits have more than 5 input pins.

### BACKGROUND OF THE INVENTION

(1) Field of the Invention

The present invention relates to the field of digital arithmetic circuits, more specifically, to the One Step Binary Summarizer (OSBS) circuit.

U.S. Pat. No. 7,991,820

Date: Aug. 2, 2011,

Inventor and owner: Sohay, Leslie Imre (myself).

(2) Description of related art

Most of today's computers are performing arithmetic operations, by using an adder circuit. The subtraction can be treated as an addition by the use of complementary numbers (witch includes: double additions, multiple moves, temporary storage).

The subtraction can also be treated as a single addition with the use of the One Step Binary Summarizer's Claim 10 “carry concept” method, which is not based on the complementary number system.

FIG. 1A (Prior Art) drawing 100 illustrates a well-known, conventional 1-bit full adder. As illustrated in FIG. 1A drawing 100, a conventional 1-bit full adder is comprised of a “first” XOR logic gate 102 that receives input values from the A and B registers, which contain or hold two numbers or operands on which the addition operation of the full adder 100 will operate. The A and B registers are further coupled to an AND function logic gate 108. With the combination of the first XOR logic gate 102 and the AND logic gate 108 forming the first half of the full adder. Further included with the full adder 100 of FIG. 1A are a second XOR logic gate 104, a second AND logic gate 106, and an OR logic gate 110, which combine the “Carry” signals form the current bit and from the previous bit's operation, forming the full adder circuit 100.

The function of the first AND logic gate 108 is to generate the “Carry” signal if both of the input operands has a high (=1) input value. The function of the second AND logic gate 106 is to generate the “Carry” signal if only one of the input operands and the Carry from the previous adjacent lower Bit's operation has a high (=1) input value. It is also known as a ripple carry. It must be noted, that it requires 6 propagation delays (PD), or logic level to complete the addition of 1 set of input operands addition, that is: 2 for the first XOR gate+1 for the AND gates+1 for OR gate+2 for the second XOR gate. (2+1+1+2=6). This adder circuit is known as parallel adder, however, only the first XOR gates are operating in the same time. Each bit always must wait for the previous bits carry signal, which is called as ripple carry. Therefore the total time is required for a 64 Bit wide parallel adder's carry process is 64 times 2 propagation delays, totaling 128 PD. The actual adding needs the first and the second XOR gates delay+the ripple carry, which adds up to 132 propagation delays (2+2+128). Since the full parallel Adder circuits are well-known and has been in use for over 60 years, no further explanation is required. FIG. 1B is the flowchart of the Adder circuit, where Line 112 is corresponding with the current input signal levels.

### SUMMARY OF THE INVENTION

This invention will accelerate the subtraction operation by replacing the ripple carry method with a true parallel carry system. This invention is simultaneously generating all Carry signals for all available Bits, reducing the carry generation time to 2 propagation delays for a subtractor circuit. The number of Bits are used by the subtractor circuit is not limited. For a 64 Bit wide subtractor circuit of this invention will generate all carry signals using only 2 propagation delays time or 2 logic levels. That is 128 times faster than the conventional parallel adder using twos complement subtraction (double addition) with the ripple carry method (256/2=128). This acceleration of the subtraction is achievable by utilizing Claim 9, 10 and Claim 11 of the One Step Binary Summarizer circuit, which is eliminating all complement operations, including: double addition, multiple moves, iterative instructions sets for the subtraction operation, and has a capability to subtract the smaller magnitude operand from the larger magnitude operand; regardless which input operand is the Minuend ad which is the Subtrahend, without moving the operands or duplicating the circuitry. Similarly for the Carry Look Ahead Adder circuit, this invention can operate in two different formats: the “Pure” format which requires high number of components, and a grouped format, where the number of components in used are considerably reduced.

The industry standard for subtracting two numbers is the use of a binary complement system (mostly twos complement). The worst weakness of this system is: it requires two addition operations. Therefore the above indicated numbers must be doubled for a subtraction operation. Carry generation requires 256 propagation delays, and the subtraction operation requires 264 propagation delays.

Most computer systems are using a Carry Look Ahead Buffer circuit to accelerate the speed of the adder circuits carry system.

FIG. 2A (Prior Art) drawing 200 illustrates the subtractor circuit of the One Step Binary Summarizer circuit. FIG. 2A is the exact copy of the patent application of the One Step Binary Summarizer circuit (FIG. 2E); therefore all information has been detailed in the U.S. Pat. No. 7,991,820. FIG. 2B is the flowchart of the Subtractor circuit, where Line 212 is corresponding with the current input signal levels.

The carry structure of FIG. 1A (Prior Art); (AND gate 106, AND gate 108 and OR gate 110 of the Adder circuit) is identical to the carry structure of the FIG. 2A (Prior Art); (AND gate 206, AND gate 208 and OR gate 210 of the Subtractor circuit). The differences of the circuits are the input points of the carry structures. Both of the carry structures are installed as a ripple carry system; therefore the propagation delays for a 64 Bit adder or subtractor circuit are identical (=128 PD). It must be noted; this FIG. 2A of the OSBS subtraction circuit is NOT using the twos complementary subtraction method; therefore if it does NOT need the second addition.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Throughout the disclosure, the words “logic gate” is used exclusively to mean a logical function combination of electronic components and not a specific integrated circuit.

Referring to the drawings in which like-referenced character(s) present corresponding parts throughout:

FIG. 1A is an exemplary prior art illustration for an adder circuit;

FIG. 1B is a prior art illustration of a flowchart, where Line 112 is corresponding with the input settings of FIG. 1A;

FIG. 2A is an exemplary prior art illustration for a subtractor circuit of the One Step Binary Summarizer circuit;

FIG. 2B is a prior art illustration of a flowchart, where Line 212 is corresponding with the input settings of FIG. 2A;

FIG. 3A is an exemplary prior art illustration of a typical bit of a Carry Look Ahead buffer system, where drawing 300 is the adder circuit and Rule 1 and Rule 2 carry generator circuitry and drawing 310 is the Carry Generator and Carry Selector Module—for the current Bit;

FIG. 4A is an exemplary illustration of a typical bit of the Subtractor Accelerator system, where drawing 400 is comprising the subtractor circuit and Rule 1 and Rule 2 carry generator circuitry and drawing 410 circuit comprising the Carry Generator and Carry Selector Module (for the current Bit) in accordance with the present invention;

FIG. 4B is an exemplary illustration of a CLA merging Module, where the currently used Carry Look Ahead Buffer of the adder circuit can be used for the subtraction operation as well, drawing 420 is selecting the addition's and the subtraction's Rule 1 Carry signals, and drawing 430 is selecting the addition's and the subtraction's Rule 2 Carry signals in accordance with the present invention;

FIG. 4C is an exemplary illustration of a flowchart, where Line 412 is corresponding with the input settings of FIG. 4B in accordance with the present invention;

FIG. 4D is an exemplary illustration of a typical bit of the Subtractor Accelerator system for Mirroring Adapter Module, where drawing 450 is selecting the B-Register as the subtrahend operand; and drawing 460 is selecting the A-Register as the subtrahend operand in accordance with the present invention;

FIG. 5A is an exemplary illustration of the carry generator circuit of Bit 4 of a grouped configuration in accordance with the present invention;

FIG. 5B is an exemplary illustration of the carry generator circuit of Bit 5 of a grouped configuration in accordance with the present invention;

FIG. 5C is an exemplary illustration of the carry generator circuit of Bit 6 of a grouped configuration in accordance with the present invention;

FIG. 5D is an exemplary illustration of the carry generator circuit of Bit 7 of a grouped configuration in accordance with the present invention;

FIG. 6A is an exemplary illustration of a high magnitude detector circuit for a group, comprising Bit 4, Bit 5, Bit 6, and Bit 7 in accordance with the present invention;

FIG. 7A is an exemplary illustration of Rule 1 Carry transfer circuits, where drawing 720 is adjusting the group: comprising Bit 0, Bit 1, Bit 2, and Bit 3, and drawing 740 is adjusting the group: comprising Bit 4, Bit 5, Bit 6, and Bit 7 in accordance with the present invention;

FIG. 7B is an exemplary illustration of Rule 1 Carry transfer circuits, where drawing 760 is adjusting the group: comprising Bit 8, Bit 9, Bit 10, and Bit 11, and drawing 780 is adjusting the group: comprising Bit 12, Bit 13, Bit 14, and Bit 15 in accordance with the present invention.

### DETAILED DESCRIPTION OF THE INVENTION

The detailed description set forth below in connection with the appended drawings is intended as a description of presently preferred embodiments of the improvements and is not intended to represent as the only forms in which the improvements may be constructed and/or utilized.

For purposes of illustration, the various circuit topographies illustrated throughout the disclosure use logic gates, which are symbolic representations of logic functions. The disclosure should not be limited by any specific symbol, logic gate, or any other representation of a logic function, but by the actual logic function itself. Non-limiting examples of logic gates representing logic functions may include AND, NAND, OR, NOR, XOR, XNOR, INV (inverter), or a combination thereof, etc. It should be noted that reference to “first,” “second,” “third, “final” etc. members throughout the disclosure, including the claims, are not used to show a serial or numerical limitation but instead are used to distinguish or identify the various members of the group.

The One Step Binary Summarizer (U.S. Pat. No. 7,991,820) includes the following:

“Claim 9: The One Step Binary Summarizer according to claim 7: wherein, in the subtraction operation The One Step Binary Summarizer circuit subtracts the smaller magnitude operand from a larger magnitude operand based on the final Bit's subtraction carry signal.

Claim 10: The One Step Binary Summarizer according to claim 1; wherein, for the subtraction operation, the One Step Binary Summarizer circuit utilizes a subtraction-by-addition method (carry concept) instead of the traditional subtraction by borrowing method.

Claim 11: The One Step Binary Summarizer circuit according to claim 10: wherein, in the subtraction operation, the carry is generated when the minuend operand has a low logic level and the subtrahend operand has a high logic level, or the two input operand have identical logic levels and a carry from the previous bits operation has a high logic level.”

This invention is utilizing all of these three OSBS claims. Claim 11 can be separated by the meaning of the two different functions. It is needed to understand what information the subtractor circuit needs to perform a subtraction.
Rule 1: the carry is generated when the minuend operand has a low logic level (=0) and the subtrahend operand has a high logic level (=1).
Rule 2: the carry is generated when the two input operand have identical logic levels (=0 or =1) and a carry from the previous bits operation has a high logic level (=1).

Similarly: the rules for the addition operation are:
Rule 1: the carry is generated when both of the two input operands have a high logic level (=1).
Rule 2: the carry is generated when only one of input operand has a high logic level (=1) and the carry from the previous bits operation has a high logic level (=1).

We can rephrase both sets of rules without changing the result, but getting a cleaner understanding how similar the two carry systems are.

The rephrased rules for the subtraction operation are:
Rule 1: the carry is generated when ONLY the subtrahend operand has a high logic level (=1).
Rule 2: the carry is generated when the two input operands are IDENTICAL and the carry from the previous bits operation has a high logic level (=1).

The rephrased rules for the addition operation are:
Rule 1: the carry is generated when the two input operands have IDENTICAL high logic level (=1).
Rule 2: the carry is generated when the two input operands are NOT IDENTICAL (different) and the carry from the previous bits operation has a high logic level (=1).

It means; for both carry systems Rule 1 depends only on the two input operands; Rule 2 also depends on the two input operands, but also must have a high logic level (=1) from the previous bit's Rule 1 carry operation as well.

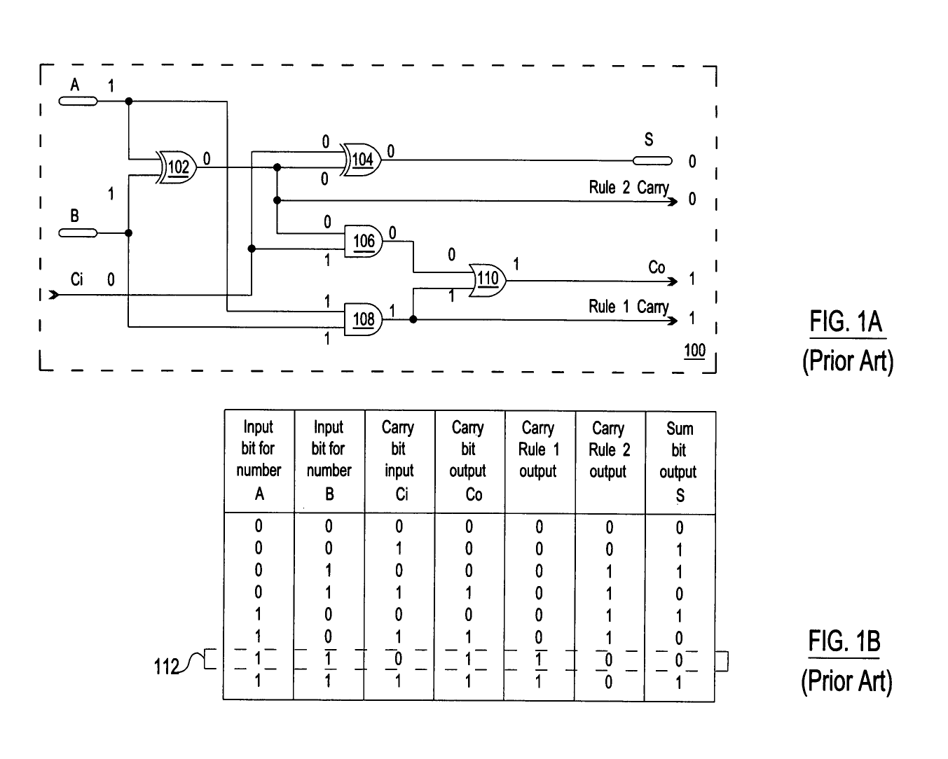

As illustrated in Prior Art FIG. 1A: a conventional Adder circuit contains a “first” XOR logic gate 102 and a “second” XOR logic gate 104. It is true for each Bit of an Adder circuit; therefore a 64 bit adder must contain 64 “first” XOR logic gates 102.

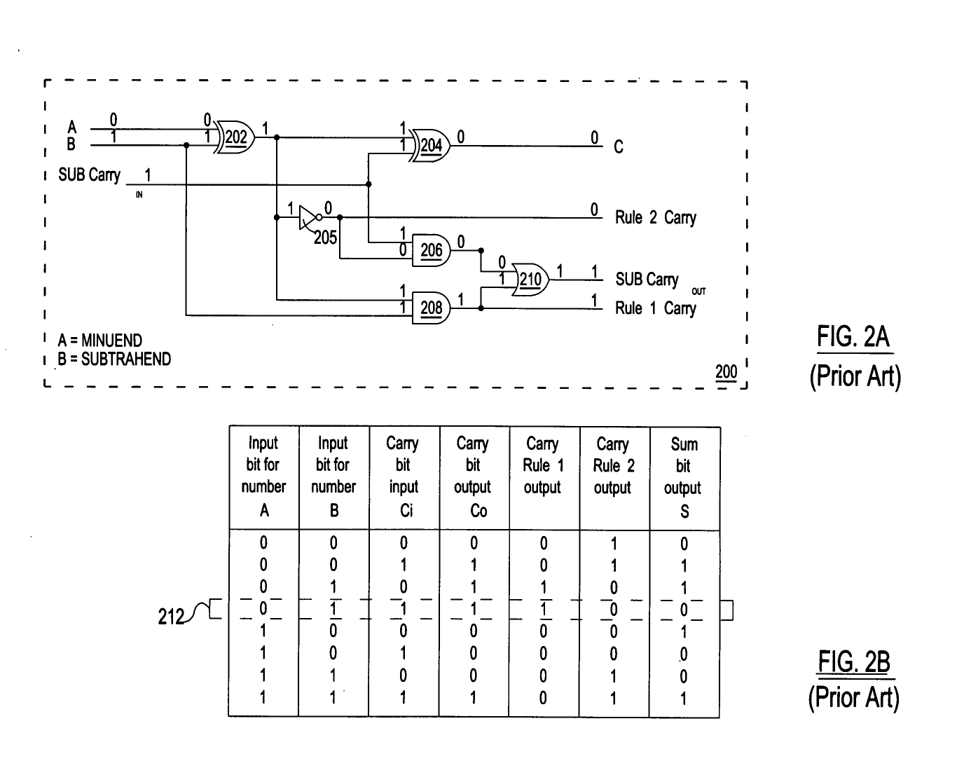

Similarly for Prior Art FIG. 1A, in Prior Art FIG. 2A the One Step Binary Summarizer's subtraction circuit contains a “first” XOR (or XNOR) logic gate 202 and a “second” XOR logic gate 204.

Because every Bit must have the same gates, all “first” XOR gates are using the same Identification number of 202 and all “second” XOR logic gates are using the same Identification number of 204. To differentiate between the multiple numbers of 202 and 204, the Bit number identification must be used.
For example: first XOR logic gate 202 of Bit 3
   second XOR logic gate 204 of Bit 9.

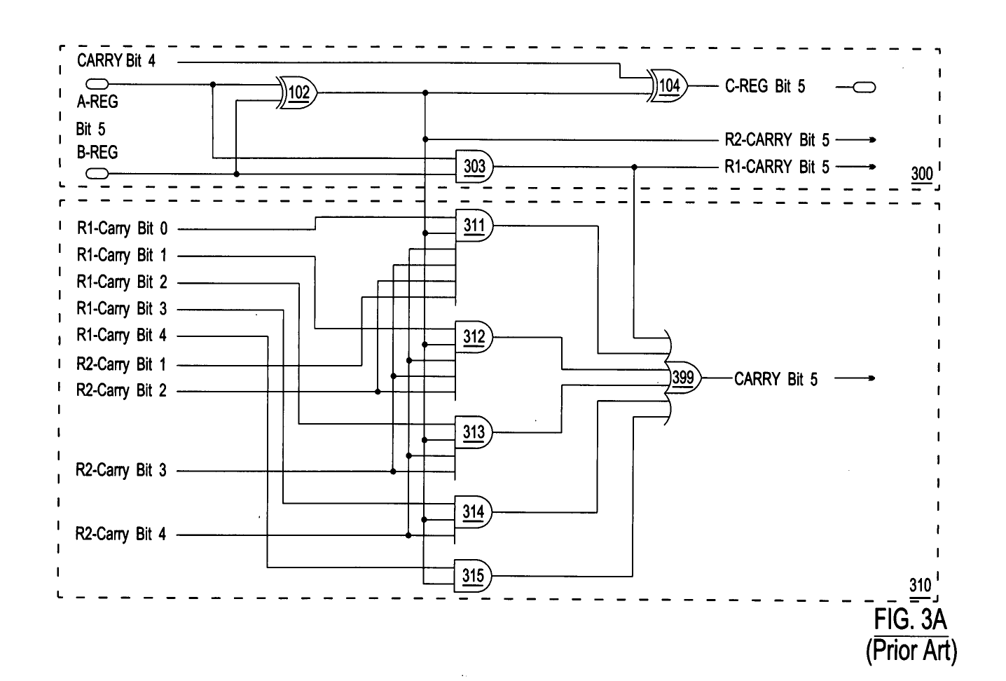

Prior Art FIG. 3A is the drawing of Bit 5 of a Pure Carry Look Ahead Adder circuit.

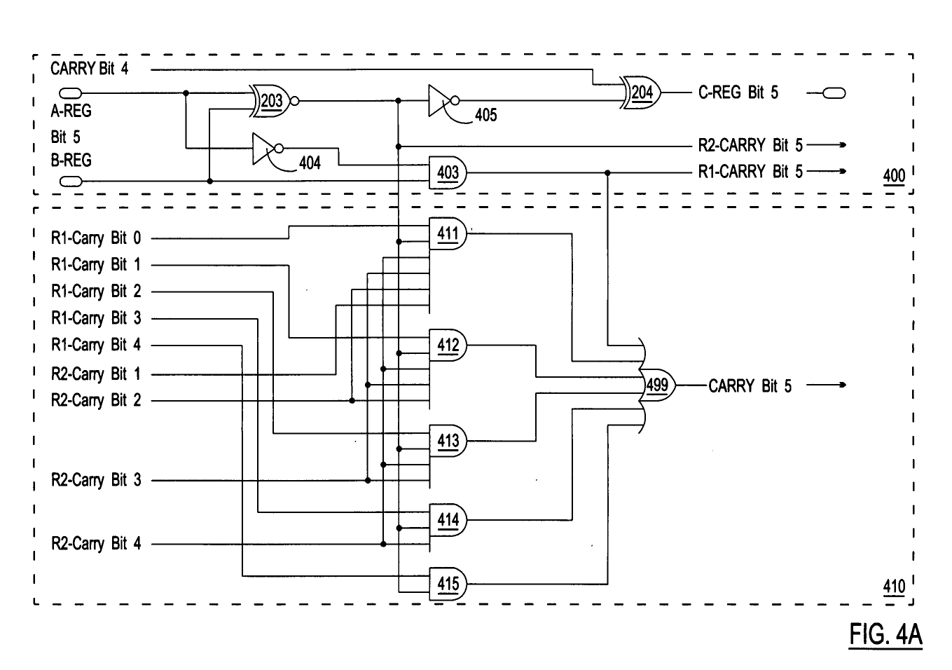

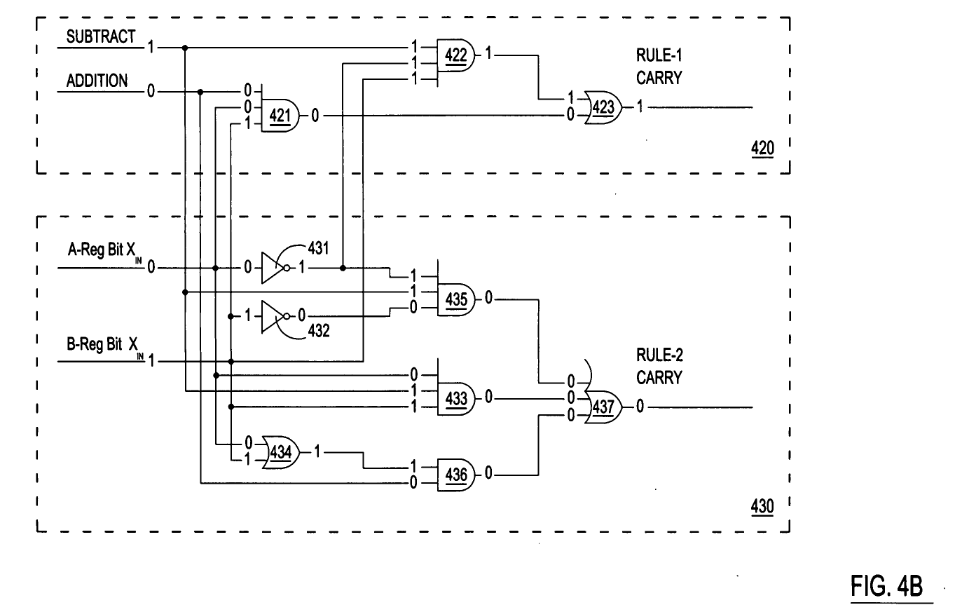

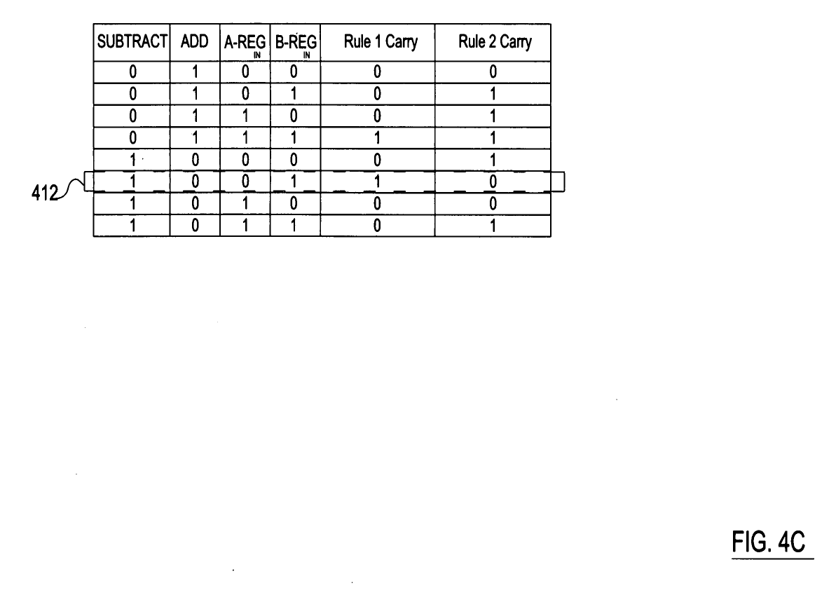

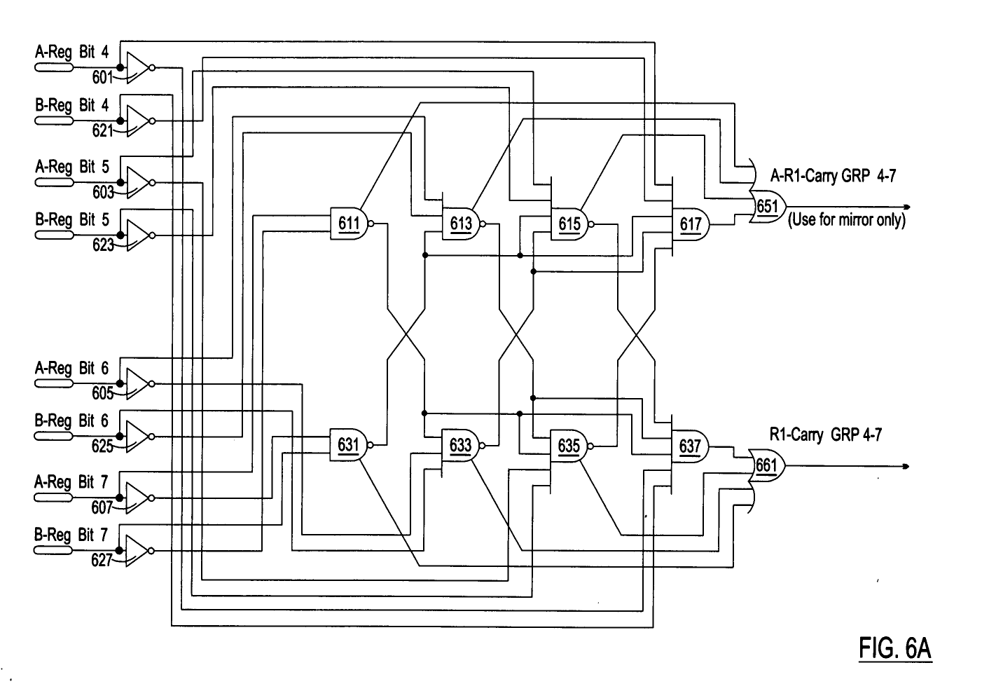

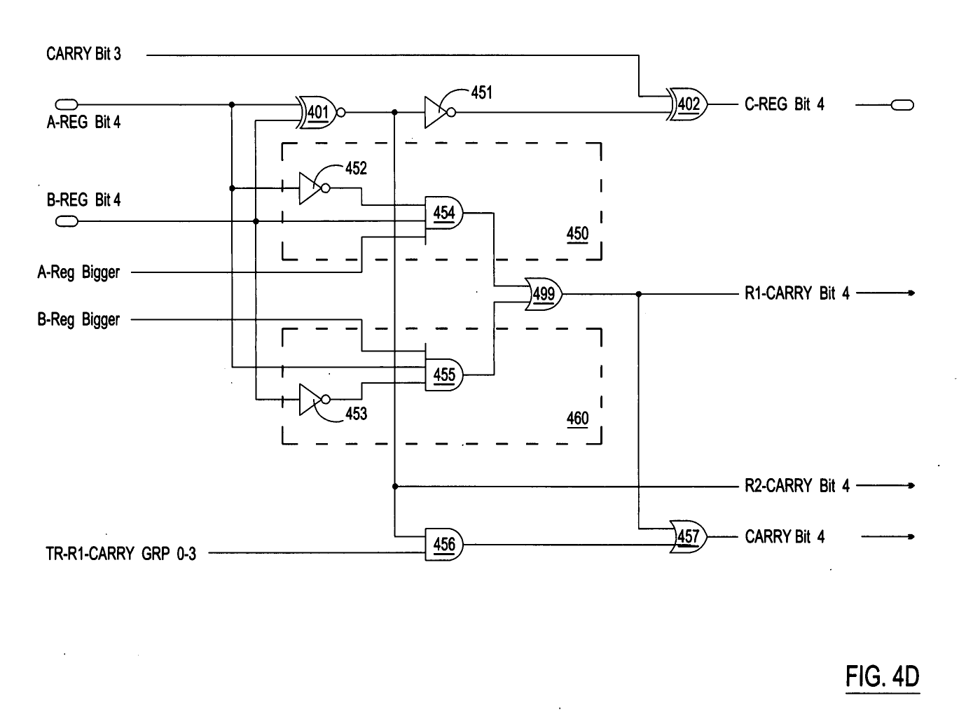

FIG. 4A is the drawing of Bit 5 of the current invention's stand alone (Pure) configuration. It can be considered as typical subtractor bit since all Bits have the similar logic structure for the stand alone configuration. All Bits includes the first XNOR gate 203, the second XOR gate 204, a carry selector OR gate 499 and numerous carry generator AND gates 4xx.

In this configuration the A-Register is the MINUEND and the B-Register id the SUBTRAHEND.

In drawing 400 the first XNOR 203 of Bit 5 is connected to the A-REG Bit 5 (input register) and to the B-REG Bit 5 (input register). The first XNOR 203 of Bit 5's XNOR output is connected to the one of the second XOR gate's 204 of Bit 5's inputs via the INV gate 405. The first XNOR 203 of Bit 5's output is identified as R2-Carry Bit 5 and connected to all lower bit's final carry generator AND gates (Bit 0's 411, Bit 1's 412, Bit 2's 413, Bit 3's 414, Bit 4's 415). This is complying with the subtraction's carry generation Rule 2.

A-REG Bit 5 (input register) also connected to the AND gate 403 via the INV gate 404. The B-REG Bit 5 (input register) also connected to the AND gate 403. If the A-REG Bit 5 has a low logic level (=0) and the B-REG Bit 5 has a high logic level (=1), the AND gate 403 is generating a high logic level R1 Carry signal. This is complying with the subtraction's carry generation Rule 1.

Note: the words “final carry” are used several times in this document and they are associated with the Carry Generating AND gates 4XX which input signal are the Rule 2 carry signals and the output signals are directly connected to a Carry Selector OR gate 499 of the corresponding data bit.

The output of the AND gate 403 (Rule 1 carry) is connected to one of the inputs the carry selector OR gate 499 and also connected to all higher bits as R1-Carry Bit 5. This “higher” bits connection applies to only one AND gate for each bits. The output of the OR gate 499 of Bit 5 (CARRY Bit 5) is connected to next higher bit's (in this case Bit 6) second XOR gate's 204 open input. As it is noticeable: it is the only connection of this final carry signal; therefore the CARRY Bit X (X is the current bit number) has no influence to the rest of the Subtractor circuit, no ripple affect can occur.

The final carry generator AND gate 411 of Bit 5 is also receiving a connection from R1-Carry Bit 0 and R2-Carry Bit 1, R2-Carry Bit 2, R2-Carry Bit 3, and R2-Carry Bit 4. The final carry generator AND gate 412 of Bit 5 is also receiving a connection from R1-Carry Bit 1 and R2-Carry Bit 2, R2-Carry Bit 3, and R2-Carry Bit 4. The final carry generator AND gate 413 of Bit 5 is also receiving a connection from R1-Carry Bit 2, R2-Carry Bit 3, and R2-Carry Bit 4. The final carry generator AND gate 414 of Bit 5 is also receiving a connection from R1-Carry Bit 3 and R2-Carry Bit 4. The final carry generator AND gate 415 of Bit 5 is also receiving a connection from R1-Carry Bit 4. R2-Carry Bit 5 is the current Bit's signal. As it is noticeable, every carry generator AND gate has only one R1-Carry Bit connection and they are also connected to all higher Bit's R2-Carry Bit signals. All final carry generator AND gates of Bit 5 are connected to the carry selector OR gate 499 of Bit 5.

As explained above: the carry signal from the carry selector OR gates 499 of all Bits have only one output connection: to the next higher Bit's second XOR gate 204. Therefore the subtractor circuit does NOT have to wait for a carry to be generated, no carry ripple can occur, and all final carries are generated simultaneously; therefore it is a true parallel subtractor circuit.

To compare the Prior Art FIG. 3A drawing 310 which is a Pure Carry Look Ahead Adder circuit with FIG. 4A drawing 410 (Carry Generator and Carry Selector Module) of the present invention, it must be noticeable: the logic structure of the two drawings is identical (except the gate numberings). It is indicating: the “Pure” Carry Look Ahead adder circuit can be used for the subtraction operation as well, without the double addition, multiple moves, . . . required by the twos complement subtraction.

There is a difference between the Prior Art FIG. 3A drawing 300 and the FIG. 4A drawing 400. The differences are described earlier (Prior Art FIG. 1A and Prior Art FIG. 2A). The XOR gate 102 of drawing 300 is replaced with the first XNOR 203 for the drawing 400. Additionally for the Subtractor circuit to compensate for the XNOR gate 203, an INV gate 405 must be used, which is connecting the first XNOR gate 203 to the second XOR gate 204. It does not slowing down the operation, but saves one propagation delay for the Rule 2 Carry generation. This way for the subtraction operation both Rule 1 and Rule 2 Carries will be generated in the same time (2 propagation delays).

FIG. 4B comprises a CLA Module for selecting the “Pure” Carry Look Ahead Adder to be used as an ADDER or as a SUBTRACTOR without any modification to the Carry Generator and Carry Selector Module. (Prior Art FIG. 3A Drawing 310, and FIG. 4A Drawing 410).

FIG. 4B Drawing 420 is selecting the Rule 1 carries of the addition and the subtraction operations. FIG. 4B Drawing 430 is selecting the Rule 2 carries of the addition and the subtraction operations.

In drawing 420 the 3 input AND gate 422 is receiving a connection from the SUBTRACT input signal. AND gate 422 is also receiving a connection from the B-Reg Bit X input signal. (In Bit X the letter X is representing the appropriate Bit number). The third input connection of the AND gate 422 is the inverted A-Reg Bit X input signal via the INV gate 431. These sets of connections are complying with Rule 1 of the Subtraction operation. The 3 input AND gate 421 is receiving a connection from the ADDITION input signal. AND gate 421 is also receiving a connection from the B-Reg Bit X input signal. The third input connection of the AND gate 421 is the inverted A-Reg Bit X input signal. These sets of connections are complying with Rule 1 of the ADDITION operation. Since the circuit can be either adding or subtracting at any given time, only one of the AND gate 421 or the AND gate 422 can generate a high logic level (=1) signal. The outputs of the AND gate 421 and the AND gate 422 are connected to the OR gate 423 for selecting the correct Rule 1 Carry signal.

In drawing 430 the 3 input AND gate 435 is receiving a connection from the SUBTRACT input signal. AND gate 435 is also receiving a connection from the inverted A-Reg Bit X input signal via the INV gate 431. The third input connection of the AND gate 435 is the inverted B-Reg Bit X input signal via the INV gate 432. These sets of connections are complying with Rule 2 of the Subtraction operation if both input operands have a low logic level (=0). The 3 input AND gate 433 is receiving a connection from the SUBTRACT input signal, from the A-Reg Bit X input signal and from the B-Reg Bit X input signal. These sets of connections are complying with Rule 2 of the Subtraction operation if both input operands have a high logic level (=1). The 2 input OR gate 434 is receiving a connection from the A-Reg Bit X input signal and the B-Reg Bit X input signal. The output of the OR gate 434 is connected to the 2 input AND gate 436. The second input of the AND gate 436 is connected to the ADDITION input signal. These sets of connections are complying with Rule 2 of the Addition operation only input operands have a high logic level (=1). The outputs of the AND gate 433 and the AND gate 435 and the AND gate 436 are connected to the OR gate 437 for selecting the correct Rule 2 Carry signal.

FIG. 4C is the flowchart of the Carry Look Ahead Adapter circuit, where Line 412 is corresponding with the current input signal logic levels of FIG. 4B's drawings.

FIG. 4D comprises an adapter circuit for allowing the A-register and the B-register to be “mirrored” without duplicating most of the components. This mirroring adapter will subtract the smaller magnitude operand from the larger magnitude operand based on Claim 9 of The One Step Binary Summarizer. If the subtrahend operand is larger than the minuend operand, this adapter will swap the two operands functions, in other words: it is selecting which operand's Rule 1 carry signal should be used by the subtractor circuit. It will return the correct result with the indication of a negative sign bit. This mirroring circuit should be included in all set of bits.

FIG. 4D drawing represents Bit 4. A-Register Bit 4 is connected to the first XNOR gate 401. B-Register Bit 4 is also connected to the first XNOR gate 401. The output of the XNOR gate 401 is identified as R2-Carry Bit 4 and it is connected to the second XOR gate 402 via the INV gate 451. The second input of the second XOR gate 402 is the Carry Bit 3 from the previous bits operation. The output of the second XOR gate 402 is the resultant operand's Bit 4.

In drawing 450: A-Register Bit 4 is connected to the three input AND gate 454 via the INV gate 452. B-Register Bit 4 is also connected to AND gate 454. The third input connection of the AND gate 454 is the A-Reg Bigger signal. If the A-Register has higher magnitude than the B-Register, then it will enable the AND gate 454 to generate the R1 Carry signal. The output of the AND gate 454 is connected to one of the inputs of the carry selector OR gate 499 of Bit 4, which is producing the R1-Carry Bit 4 signal.

In drawing 460: A-Register Bit 4 is connected to the three input AND gate 455. B-Register Bit 4 is also connected to AND gate 455 via the INV gate 453. The third input connection of the AND gate 455 is the B-Reg Bigger signal. If the B-Register has higher magnitude than the A-Register, then it will enable the AND gate 455 to generate the R1 Carry signal. The output of the AND gate 455 is connected to one of the inputs of the carry selector OR gate 499, which is producing the R1-Carry Bit 4 signal.

As noticeable, Drawings 450 and 460 are mirror images of each others. The selection for the usage is depends only on the input operands magnitudes, therefore the possibility for an error indication for subtracting a higher magnitude from a smaller magnitude operand is eliminated. Only one of the operand can be larger than the other. The two input operands can be identical and in this case the carry generation will produce a low logic level (=0) signal and the resultant operand's value will be zero.

The stand alone (Pure) configuration of the Carry Look Ahead Adapter circuit whether it is used for addition or subtraction has a weakness; it requires large amount components, more specifically large amount of final Carry Generator AND gates 4XX. (XX is representing a corresponding bit number). Further more, those AND gates 4XX and the carry selector OR gates 499 must have large amount of input pins as well. The formula to calculate the final Carry Generator AND gates 4XX is: Y=(N²+N)/2, where Y is the number of AND gates 4XX are needed, and N is the number Bits are used for the adder-subtractor circuit.

For a 64 Bit adder-subtractor circuit this number is: (64²+64)/2=2080.

For an 8 Bit adder-subtractor circuit this number is: (8²+8)/2=36.

There are numerous ways to perform a subtraction. The Subtrahend can be subtracted from the Minuend as one set of numbers or one group of numbers; this is the stand alone (Pure) configuration. However, both operands can be separated to different size of groups and subtract each groups independently, this is the grouped or distributed configuration.

For example in decimal format: where “A” is representing the stand alone or one group format, and “B” is representing a grouped or distributed format. The values of the two sets of numbers are identical.

$$\begin{matrix}\begin{matrix}\underline{\begin{matrix}788345784 \\ - 551495021\end{matrix}} \\ = 236850763\end{matrix} & A \\ \begin{matrix}\underline{\begin{matrix}788 & 345 & 784 \\ - 551 & 495 & 021\end{matrix}} \\ \begin{matrix}= 236 & 850 & 763\end{matrix}\end{matrix} & B\end{matrix}$$

The words: “adjustment” or “transfer” is used several times in this invention. The purpose or function of the transfer is:

The high magnitude detection is analyzing a set of Bits within the groups. If all pairs are identical, then it will return a result as identical, which is true. However, if the high logic level (=1) of carry is present from one of the previous Rule1 Bit X signal, it must transferred to all of the following consecutively identical R2-Carry Bits, therefore and all of the following consecutively identical R2-Carry Bits must generate the same carry signal, regardless how many R2-Carry Bits are following. The number of consecutively identical R2-Carry Bits may exceed the size of the group, which means: the carry signal must follow trough the group's borders. The side benefit of the Transfer is: it is automatically generating the correct Rule 1 carry signals for the highest Bit number of each group, thereby reducing the quantity of carry generator AND gates are used. In the following case the IDENTICAL GROUP is the middle group and it contains 3 digits=3 Rule 2 Carry signals. For example in decimal format:

$$\begin{matrix}\begin{matrix}\underline{\begin{matrix}788 & 345 & 484 \\ - 551 & 345 & 321\end{matrix}} \\ \begin{matrix}237 & 000 & 163\end{matrix}\end{matrix} & A \\ \begin{matrix}\underline{\begin{matrix}788 & 345 & 484 \\ - 551 & 345 & 521\end{matrix}} \\ \begin{matrix}236 & 999 & 963\end{matrix}\end{matrix} & B\end{matrix}$$

NOTE for the following explanations: This invention is utilizes a subtraction-by-addition method (carry concept) instead of the traditional subtraction by borrowing method. (Claim 10 of the One Step Binary Summarized).

In sample A the middle group (345) does not receives a high logic level (=1) carry signal from the previous group, because the lowest group's subtrahend (321) is smaller than the lowest group's minuend (484). As it is indicated by the independently executed subtraction of the middle group resulting 000 (low logic level carry (=0)).

In sample B the middle group (345) receives a high logic level (=1) carry from the previous group, because the lowest group's subtrahend (521) is larger than the lowest group's minuend (484) and it is indicated by the independently executed subtraction of the middle group resulting 000 and the carry must be added to each middle group's digit, (high logic level carry (=1) in decimal format the value of the carry=10). This carry must be transferred to the third group to receive the correct result. The carry signal is “walking” trough the group borders. The result value of the IDENTICAL GROUPS may change, but remains identical (000 or 999), where 000=low Rule 2 Carry (signal), and 999=high Rule 2 Carry (signal).

This rule is identical for any numbering system, including the binary:

For example in binary format:

$$\begin{matrix}\begin{matrix}\underline{\begin{matrix}101 & 101 & 011 \\ - 011 & 101 & 001\end{matrix}} \\ \begin{matrix}010 & 000 & 010\end{matrix}\end{matrix} & A \\ \begin{matrix}\underline{\begin{matrix}101 & 101 & 011 \\ - 011 & 101 & 100\end{matrix}} \\ \begin{matrix}001 & 111 & 111\end{matrix}\end{matrix} & B\end{matrix}$$

As it is noticeable; if the “lower” group's value is higher for the subtrahend operand than the minuend operand, then the “middle” group's value for each numbers or Bits is always the highest value of the numbering system single digit value. That is 1 for the binary, 7 for the octal, 9 for the decimal and F for the hexadecimal numbering systems.

Since this invention works with true parallel carry generation method, without the “ripple effect”, other solutions are available to accelerate the subtraction operation beside the stand alone or “Pure” configuration. The other solutions are the grouping of the input operands, where each groups are simultaneously, but independently subtracted by using the subtraction-by-addition method (carry concept). It can be done in several different ways. All groping configurations have component saving advantage, but also have performance disadvantage over the stand alone “Pure” configuration.

As stated earlier:

A 64 Bit adder-subtractor circuit requires (64²+64)/2=2080 final Carry Generator AND gates.

An 8 Bit adder-subtractor circuit requires (8²+8)/2=36 final Carry Generator AND gates.

One of the grouping options is the 8 by 8 configuration. It has 8 groups, and each group contains 8 Bits. As it is indicated above the 8 Bit subtractor needs only 36 of carry generator AND gates 4XX. This number must be multiplied by 8 to have the 64 Bit wide subtractor. It is (8*36=288); however (7*8=56) must be deducted from this number, because the carry transfer routine (will be explained later) is automatically and simultaneously creating the highest Bit's carry signal of each and all groups. Therefore the total number of final carry generator AND gates 4XX is 232. It is almost 90% components saving, which is a very considerable number.

The routine is the following for the 8 by 8 configuration circuit:

1/Simultaneous high magnitude detection for each of the groups Bits 0-7, Bits 8-15, Bits 16-23, Bits 24-31, Bits 32-39, Bits 40-47, Bits 48-55, and Bits 56-63. This detection will generate the groups of GRP 0-7, GRP 8-15, GRP 16-23, GRP 24-31, GRP 32-39, GRP 40-47, GRP 48-55, and GRP 56-63.
2/Simultaneous adjustment (carry transfer) for groups GRP 0-7, GRP 8-15, GRP 16-23, GRP 24-31, GRP 32-39, GRP 40-47, GRP 48-55, and GRP 56-63. This adjustment could change logic levels of any group; therefore all groups needs to be identified as adjusted by adding the letters “TR-” in the front of each original signal names, and the new signal names will be: TR-R1-Carry GRP 0-7, TR-R1-Carry GRP 8-15, TR-R1-Carry GRP 16-23, TR-R1-Carry GRP 24-31, TR-R1-Carry GRP 32-39, TR-R1-Carry GRP 40-47, TR-R1-Carry GRP 48-55, and TR-R1-Carry GRP 56-63.
3/Simultaneous final carry generation on all sets of input operands (Bits).
4/Simultaneous execution of the second XOR gate function, Result Generation.

The carry transfer and the final carry generation routines are very similar; therefore the required time is identical to perform these operations. The time is 2 propagation delays for each of these operations. Therefore the total time requirement for this 8 by 8 configuration circuit is for subtracting a 64 Bit wide subtractor circuit is:

| | | |
|---|---|---|
| Step 1/ | high magnitude detection for the groups: | 3 propagation delays |
| Step 2/ | carry transfer for all groups: | 2 propagation delays |
| Step 3/ | carry generation on all sets of | 2 propagation delays |
| | input operands: | |
| Step 4/ | executing the second XOR gate function: | 2 propagation delays |
| | TOTAL: | 9 propagation delays |

In Prior Art FIG. 1A: The ripple adder circuit needs 2 propagation delays for the first XOR gate 102+2 propagation delays for the second XOR gate 104+1 propagation delay for the AND gates 106 and 108+1 propagation delay for OR gate 110: TOTALING 6 propagation delays for one bit. The AND gates 106 and 108 and the OR gate 110 propagation delays totaling 2, but do to the ripple method, it is repeated N times; where N=the number of Bits of the adder circuit.

The grouped configuration subtractor can perform subtraction operation on a 64 Bit wide subtractor circuit in 9 propagation delays time, which is minimum 29 times faster than the conventional parallel adder using twos complement subtraction with the ripple carry method (264/9=29.33). We should add additional time for the supporting elements of the complement operation (double additions, iterative moves, repeated instruction steps . . . )

One other grouping option is the 4 by 4 by 4 configuration. It has 4 main groups, and each main group has 4 sub-groups and each sub-group contains 4 Bits. Here the formula for calculating the carry generator AND gates is different, but the number of final carry generator AND gates 4XX are used, is less than 100. The 4 by 4 by 4 configurations can be executed in many different ways.

The routine is the following for the 4 by 4 by 4 configuration circuit:

1-A/Simultaneous high magnitude detection on all groups of 4 bits: that is Bit 0, Bit 1, Bit 2, and Bit 3, it will generate the group: GRP 0-3. The next set of Bits are Bit 4, Bit 5, Bit 6, and Bit 7, it will generate the group: GRP 4-7. Followed by Bit 8, Bit 9, Bit 10, and Bit 11, it will generate the group: GRP 8-11 . . . . All 64 Bits must be grouped and the groups must be simultaneously high magnitude detected. Bits 12-15, Bits 16-23, Bits 24-31, Bits 32-39, Bits 40-47, Bits 48-51, Bits 42-55, Bits 56-59 and Bits 60-63.
1-B/Simultaneously with step 1-A; high magnitude detection on all groups of 16. This will generate the group: GRP 0-15, GRP 16-31, GRP 32-47 and GRP 48-63.
2-A/Simultaneous adjustment (carry transfer) for groups GRP 0-3, GRP 4-7, GRP 8-11, GRP 12-15, GRP 16-19, GRP 20-23, GRP 24-27, GRP 28-31, GRP 32-35, GRP 36-39, GRP 40-43, GRP 44-47, GRP 48-51, GRP 52-55, GRP 56-59, and GRP 60-63. This adjustment could change logic levels of any group; therefore all groups needs to be identified as adjusted by adding the letters “TR-” in the front of each original signal names, and the new signal names will be: TR-R1-Carry GRP 0-3, TR-R1-Carry GRP 4-7, TR-R1-Carry GRP 8-11, TR-R1-Carry GRP 12-15, TR-R1-Carry GRP 16-19, TR-R1-Carry GRP 20-23, TR-R1-Carry GRP 24-27, TR-R1-Carry GRP 28-31, TR-R1-Carry GRP 32-35, TR-R1-Carry GRP 36-39, TR-R1-Carry GRP 40-43, TR-R1-Carry GRP 44-47, TR-R1-Carry GRP 48-51, TR-R1-Carry GRP 52-55, TR-R1-Carry GRP 56-59, and TR-R1-Carry GRP 60-63.
2-B/Simultaneously with step 2-A; adjustment (carry transfer) for groups GRP 0-15, GRP 16-31, GRP 32-47 and GRP 48-63. Similarly for step 2-A; the signal names will be changed accordingly: TR-R1-Carry GRP 0-15, TR-R1-Carry GRP 16-31, TR-R1-Carry GRP 32-47 and TR-R1-Carry GRP 48-63.
3/Simultaneous final carry generation on all sets of input operands (Bits).
4/Simultaneous execution of the second XOR gate function, Result Generation.

Similarly for the 8 by 8 configuration the total time requirement for this 4 by 4 by 4 configuration circuit for subtracting a 64 Bit wide subtractor circuit is:

| | | |
|---|---|---|
| Step 1/ | high magnitude detection for the groups: | 3 propagation delays |
| Step 2/ | carry transfer for all groups: | 2 propagation delays |
| Step 3/ | carry generation on all sets of | 2 propagation delays |
| | input operands: | |
| Step 4/ | executing the second XOR gate function: | 2 propagation delays |
| | TOTAL: | 9 propagation delays |

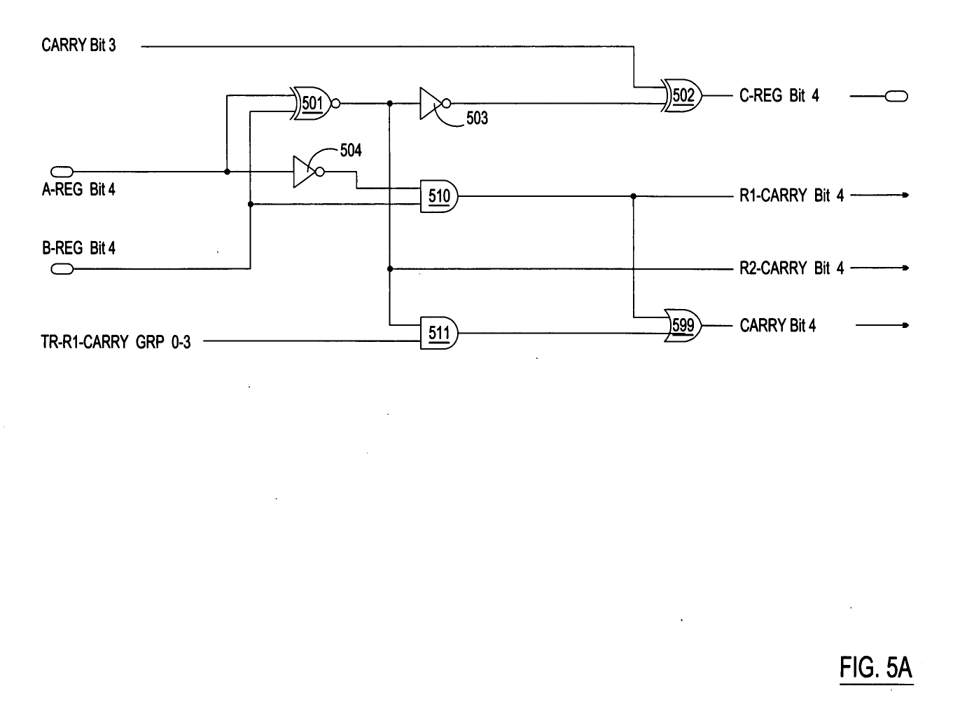

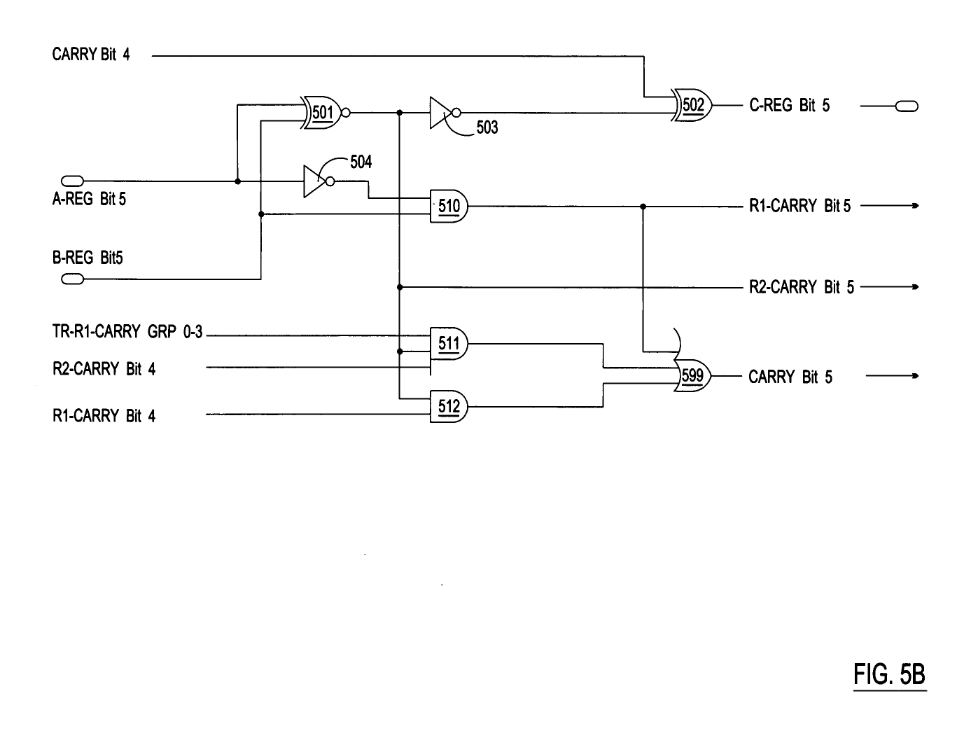

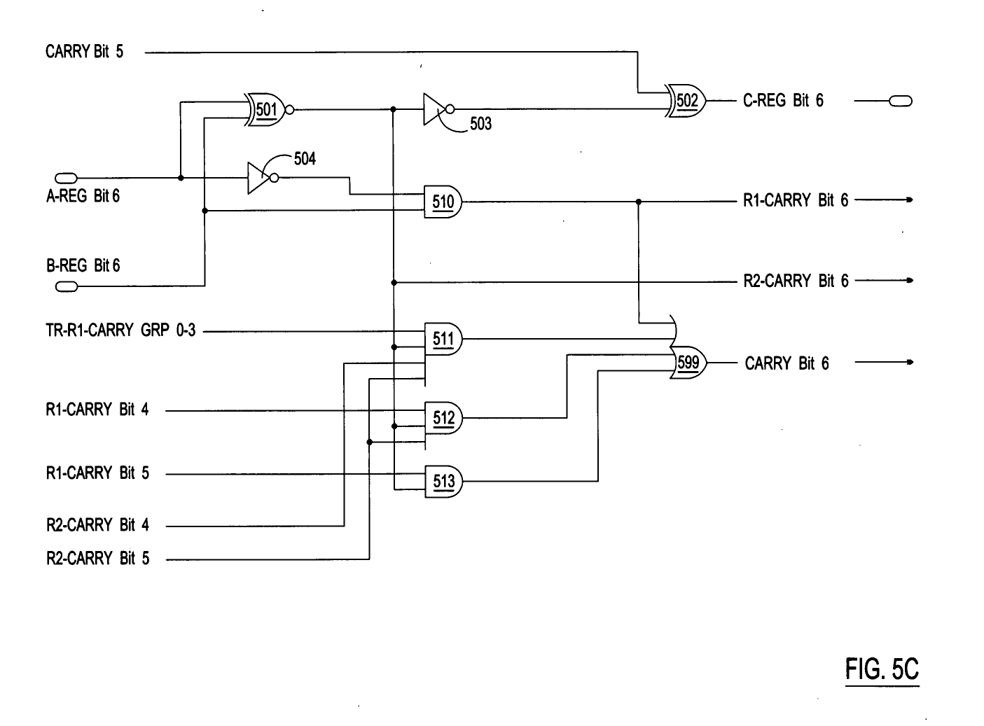

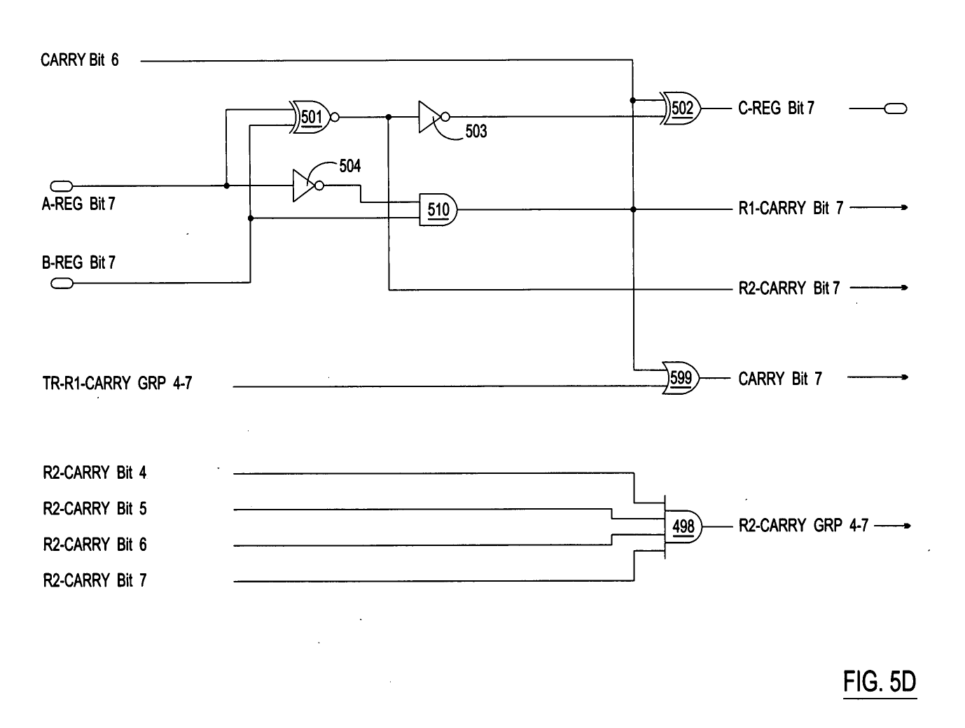

FIG. 5A is the drawing of Bit 4 of the current invention's second group (4-7) of the 4 by 4 grouped configuration of a 16 Bit wide subtractor circuit. It is also can be considered as the second sub-group (4-7) of the first main 16 bit group (0-15) of the 4 by 4 by 4 configuration of a 64 bit wide subtractor circuit. (The identification numbers of each gate in this section is related to Bit 4). The first XNOR 501 of Bit 4 is receiving a connection from the A-REG Bit 4 (input register) and from the B-REG Bit 4 (input register). The first XNOR 501 of Bit 4's output is identified as R2-Carry Bit 4, and it is connected to the one of the second XOR gate's 502 of Bit 4's inputs via the INV gate 503. It is also connected to Bit 5 and Bit 6 (its own group) and to the carry generator AND gate 511. The adjusted (transferred) TR-R1-Carry GRP 0-3 Carry signal is connected to the second input of the final carry generator AND gate 511. The A-REG Bit 4 input signal is connected via the INV gate 504 to the R1-Carry generator AND gate 510. The B-REG Bit 4 input signal is connected to the second input of the R1-Carry generator AND gate 510. The output of the AND gate 510 is identified as R1-Carry Bit 4 signal and it is connected to the carry selector OR gate 599. The carry generator AND gate 511 is also connected to the carry selector OR gate 599. The output of the carry selector OR gate 599 is the CARRY Bit 4 signal and it has ONLY one connection: to the next bit (Bit 5) second XOR gate 502. Similarly Bit 4 second XOR gate 502 is receiving the CARRY Bit 3 signal from the previous bit's operation. As noticeable all CARRY Bit X signals has only one connection: to the next higher bit second XOR gate 502; therefore, no waiting for the carry signal from the previous bit's operation and no carry ripple can occur.

FIG. 5B is the drawing of Bit 5 of the current invention's second group (4-7) of the 4 by 4 grouped configuration of a 16 Bit wide subtractor circuit. It is also can be considered as the second sub-group (4-7) of the first main 16 bit group (0-15) of the 4 by 4 by 4 configuration of a 64 bit wide subtractor circuit. (All gate identification numbers in this section is related to Bit 5.) The first XNOR 501 of Bit 5 is receiving a connection from the A-REG Bit 5 (input register) and from the B-REG Bit 5 (input register). The first XNOR 501 of Bit 5's output is identified as R2-Carry Bit 5, and it is connected to the one of the second XOR gate's 502 of Bit 5's inputs via the INV gate 503. It is also connected to Bit 6 and to the final carry generator AND gate 511, and to the final carry generator AND gate 512. The (transferred) TR-R1-Carry GRP 0-3 Carry signal is connected to the second input of the final carry generator AND gate 511. The third input of the carry generator AND gate 511 is connected to the R2-Carry Bit 4 signal. The A-REG Bit 5 input signal is connected via the INV gate 504 to the R1-Carry generator AND gate 510. The B-REG Bit 5 input signal is connected to the second input of the R1-Carry generator AND gate 510. The output of the AND gate 510 is identified as R1-Carry Bit 5 signal and it connected to the carry selector OR gate 599 and it is also connected to Bit 6. The final carry generator AND gate 512 is also receiving a connection from the R1-Carry Bit 4 input signal. The output of the final carry generator AND gate 512 is connected to the carry selector OR gate 599. The output of the carry selector OR gate 599 is the CARRY Bit 5 signal and its ONLY connection is to the next higher bit (Bit 6) second XOR gate 502. Similarly Bit 5's second XOR gate 502 is receiving the CARRY Bit 4 signal from the previous bit operation.

FIG. 5C is the drawing of Bit 6 of the current invention's second group (4-7) of the 4 by 4 grouped configuration of a 16 Bit wide subtractor circuit. It is also can be considered as the second sub-group (4-7) of the first main 16 bit group (0-15) of the 4 by 4 by 4 configuration of a 64 bit wide subtractor circuit. (All gate identification numbers in this section is related to Bit 6.) The first XNOR 501 of Bit 6 is receiving a connection from the A-REG Bit 6 (input register) and from the B-REG Bit 6 (input register). The first XNOR 501 of Bit 6's output is identified as R2-Carry Bit 6, and it is connected to the one of the second XOR gate's 502 of Bit 6's inputs via the INV gate 503. It is also connected to the final carry generator AND gate 511, AND gate 512, and to the final carry generator AND gate 513. The (transferred) TR-R1-Carry GRP 0-3 carry signal is connected to the second input of the carry generator AND gate 511. The third input of the carry generator AND gate 511 is connected to the R2-Carry Bit 4 signal, and the forth input is connected to the R2-Carry Bit 5 signal. The A-REG Bit 6 input signal is connected via the INV gate 504 to the R1-Carry generator AND gate 510. The B-REG Bit 6 input signal is connected to the second input of the R1-Carry generator AND gate 510. The output of the AND gate 510 is identified as R1-Carry Bit 6 signal and it connected to the carry selector OR gate 599. The (transferred) TR-R1-Carry GRP 0-3 Carry signal is connected to the second input of the final carry generator AND gate 511. The third input of the carry generator AND gate 511 is connected to the R2-Carry Bit 4 signal, and the fourth input of the carry generator AND gate 511 is connected to the R2-Carry Bit 5 signal. The second input of the final carry generator AND gate 512 is receiving the connection from the R1-Carry Bit 4 signal and the third input of the final carry generator AND gate 512 is connected to the R2-Carry Bit 5 signal. The output of the final carry generator AND gate 512 is connected to the carry selector OR gate 599. The R1-Carry Bit 5 signal is connected to the second input of the final carry generator AND gate 513. The output of the final carry generator AND gate 513 is also connected to the carry selector OR gate 599. The output of the carry selector OR gate 599 is the CARRY Bit 6 signal and its ONLY connection is to the next higher bit (Bit 7) second XOR gate 502. Similarly Bit 6's second XOR gate 502 is receiving the CARRY Bit 5 signal from the previous bit operation.

FIG. 5D is the drawing of Bit 7 of the current invention's second group (4-7) of the 4 by 4 grouped configuration of a 16 Bit wide subtractor circuit. It is also can be considered as the second sub-group (4-7) of the first main 16 bit group (0-15) of the 4 by 4 by 4 configuration of a 64 bit wide subtractor circuit. (All gate identification numbers in this section is related to Bit 7.) The first XNOR gate 501 of Bit 7 is receiving a connection from the A-REG Bit 7 (input register) and from the B-REG Bit 7 (input register). The output of the first XNOR gate 501 is identified as R2-Carry Bit 7, and it is connected to the one of the second XOR gate's 502 of Bit 7's inputs via the INV gate 503. The A-REG Bit 7 input signal is connected via the INV gate 504 to the R1-Carry generator AND gate 510. The B-REG Bit 6 input signal is connected to the second input of the R1-Carry generator AND gate 510. The output of the AND gate 510 is identified as R1-Carry Bit 7 signal and it connected to the carry selector OR gate 599. The TR-R1-Carry GRP 4-7 signal (it is the transferred Rule 1 carry for the Group including Bits 4, 5, 6, and 7) is connected to the carry selector OR gate 599. The output of the carry selector OR gate 599 is the CARRY Bit T signal. The CARRY Bit 7 signal is connected only to the next bit's second XOR gate 502's second input (Bit 8). Similarly Bit 7's second XOR gate 502 is receiving the CARRY Bit 6 signal from the previous bit operation.

The highest Bit of each group's does not need any final carry generator AND gate 5XX, (that is Bit 3, Bit 7, Bit 11 and Bit 15 in this 4 by 4 configuration) because the adjusted (transferred) high magnitude detection substitutes for that function. The R-2 CARRY Bit 4, R-2 CARRY Bit 5, R-2 CARRY Bit 6, and R-2 CARRY Bit 7, are connected to a four input AND gate 598. The output of the AND gate 598 is the R2-CARRY GRP 4-7 signal which is complying with Rule 2 carry generation for the present group. The R2-CARRY GRP 4-7 signal is connected for the Carry Transfer circuit and will be described later.

It should be noted that all conditions where the subtrahend operand (B-register) has a high logic level (=1) and the corresponding minuend operand (A-Register) has a low logic level (=0) will produce an automatic high logic level (=1) carry signal. This is complying with Rule 1 of the carry generation of claim 11 of the One Step Binary Summarizer circuit. The carry generator AND gates 510 and the results of the adjusted (transferred) value of the high magnitude detection of the groups (TR-R1-Carry GRP 0-3, TR-R1-Carry GRP 4-7, TR-R1-Carry GRP 8-11, TR-R1-Carry GRP 12-15 . . . ) are producing a carry signal which will be forwarded to the next bit with the applicable Rule 2 signals. This is complying with Rule 2 of the carry generation of claim 11 of the One Step Binary Summarizer circuit. Do to the parallel operation, the required time is 1 propagation delay for the final carry generator AND gates 5XX and 1 propagation delay for the carry selector OR gates 599, totaling 2 propagation delays to complete the carry generation and the carry selection process.

FIG. 6A is the drawing of a typical “up-down” high magnitude detector circuit of the current invention's 4 by 4 grouped configuration. In this case it is representing the second group (Bit 4, Bit 5, Bit 6 and Bit 7). It should be noted: this schematic is using a combination version of AND gates; where the AND function output as well as the inverted NAND function outputs is available in the same “housing”. That is both outputs are available for the same integrated circuit. If it is not possible by any technical reason the AND gates 611, 613, 615 and 617 must be installed as two paralleled gates one AND, and one NAND gate. It is also applicable for the other set of AND gates: 631, 633, 635 and 637.

All input bits are connected directly to the corresponding input registers. Each input registers have an inverted signals of itself; therefore each of the AND gates 61X and 63X can be activated only if the corresponding input operands have different values. All input signals are delivered simultaneously. All higher number low logic level (=0) input signals can simultaneously block all lower Bit's signals. Using inverters instead of the first XOR gate's output signals will save one propagation delay. These inverter gates are not “additional” components, because every one of these gates is already described in FIG. 4D as part of the mirroring subtractor circuit.

A-Reg Bit 4 is connected to the first input of AND gate 617. The inverted B-Reg Bit 4 is connected via the INV gate 621 to the second input of AND gate 617. A-Reg Bit 5 is connected to the first input of AND gate 615. The inverted B-Reg Bit 5 is connected via the INV gate 623 to the second input of AND gate 615. A-Reg Bit 6 is connected to the first input of AND gate 613. The inverted B-Reg Bit 6 is connected via the INV gate 625 to the second input of AND gate 613. A-Reg Bit 7 is connected to the first input of AND gate 611. The inverted B-Reg Bit 7 is connected via the INV gate 627 to the second input of AND gate 611.

B-Reg Bit 4 is connected to the first input of AND gate 637. The inverted A-Reg Bit 4 is connected via the INV gate 601 to the second input of AND gate 637. B-Reg Bit 5 is connected to the first input of AND gate 635. The inverted A-Reg Bit 5 is connected via the INV gate 603 to the second input of AND gate 635. B-Reg Bit 6 is connected to the first input of AND gate 613. The inverted A-Reg Bit 6 is connected via the INV gate 605 to the second input of AND gate 613. B-Reg Bit 7 is connected to the first input of AND gate 631. The inverted A-Reg Bit 7 is connected via the INV gate 607 to the second input of AND gate 631.

It should be noted: the OR gate 651 is in use only if the mirroring option is in use as described FIG. 4D.

The AND outputs of the AND gates 611, 613,615, and 617 are all connected to a 4 input OR gate 651. The AND outputs of these gate are generating the R1-Carry Group signals (in this case A-R1-Carry GRP 4-7) corresponding with Claim 11 of the One Step Binary Summarizer.

The inverted (NAND) output of AND gate 611 is connected to the AND gate 633, it is also connected to AND gate 635, and to the AND gate 637. The inverted (NAND) output of AND gate 613 is connected to the AND gate 635, it is also connected to AND gate 637. The inverted (NAND) output of AND gate 615 is connected to the AND gate 637.

The AND outputs of the AND gates 631, 633,615, and 637 are all connected to a 4 input OR gate 661. The AND outputs of these gate are generating the R1-Carry Group signals (in this case R1-Carry GRP 4-7) corresponding with Claim 11 of the One Step Binary Summarizer.

The inverted (NAND) output of AND gate 631 is connected to the AND gate 613, it is also connected to AND gate 615, and to the AND gate 617. The inverted (NAND) output of AND gate 633 is connected to the AND gate 615, it is also connected to AND gate 617. The inverted (NAND) output of AND gate 635 is connected to the AND gate 617.

If the corresponding input registers have different values, then the inverted (NAND) output signals of the dedicated AND gate will have a low logic level (=0) signal, which is disabling the all of following lower bit's AND gates from any/all possible high magnitude detection.

The following is an example in binary format, where according to FIG. 6A: the highest bit is Bit 7 and lowest is Bit 4.

Bit numbers

| | 7 | 6 | 5 | 4 |
|---|---|---|---|---|
| A-REG (Minuend) | 0 | 0 | 1 | 1 |
| B-REG (Subtrahend) | 0 | 1 | 0 | 1 |

Both input operands of the (highest) Bit 7 are supplying a low logic level (=0) signal to corresponding A-Reg Bit 7 and B-Reg Bit 7; therefore the AND gate 611 and the AND gate 631 are producing a low logic level (=0) AND output to be forwarding to the corresponding OR gate 651 and OR gate 661. The inverted (NAND) output of the AND gate 611 and the AND gate 631 are producing a high logic level (=1) to enabling the next set of lower bits for the high magnitude detection.

A-Reg Bit 6 is supplying a low logic level (=0) signal and B-Reg Bit 6 is supplying a high logic level (=1) signal; therefore the corresponding AND gate 613′ AND output is generating a low logic level (=0) signal to be forwarded to the corresponding OR gate 651, the inverted (NAND) output of the AND gate 613 is producing a high logic level (=1) to enabling the next set of lower bits for the high magnitude detection (AND gate 635, AND gate 637). The AND gate 633's AND output is generating a high logic level (=1) signal to be forwarded to the corresponding OR gate 661, and the inverted (NAND) output of the AND gate 633 is producing a low logic level (=0) to disabling all following lower bits for the high magnitude detection (AND gate 615, AND gate 617). Indicating: the B-Register has a higher magnitude than the A-Register. It is also generating the Rule 1 Carry signal (in this case R1-Carry GRP 4-7) complying with Claim 11 of the One Step Binary Summarizer. This routine is identical for all set of input operand (bits) and for all groups.

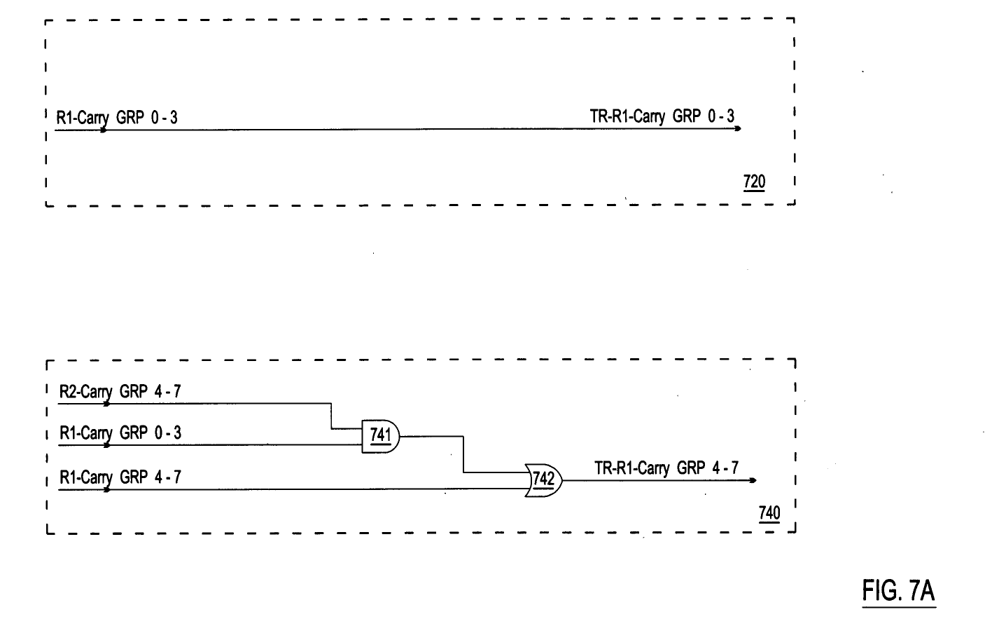

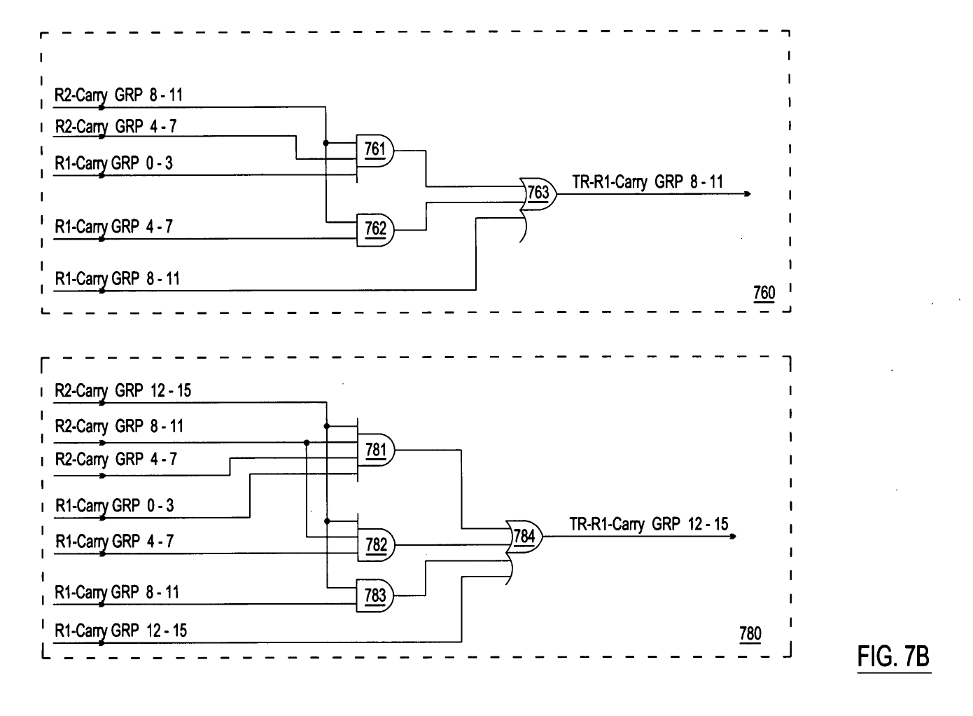

FIG. 7A includes two drawings of the Transfer circuits. As described earlier the carry signals must “walk” trough the group borders.

Drawing 720 contains the first group's signals for group 0-3. Similarly as Bit 0, which can not receive a carry signal from previous bits, the first group can not receive a carry signal from previous groups, simply because there is none. However, the signal names will be changed. The reason for the change is to stay “synchronized” with the rest of the other group's signal name changes.

Drawing 740 contains the second group's signals for group 4-7. The R2-Carry GRP 4-7 signal is connected to AND gate 741, and R1-Carry GRP 0-3 also connected to the AND gate 741. The output of the AND gate 741 is connected to one of input of the OR gate 742. R1-Carry GRP 4-7 signal is connected to the other input of the OR gate 742. The output of the OR gate 742 is the adjusted value of the second (current) group's Rule 1 Carry signal, with the signal name of TR-R1-Carry GRP 4-7. If all bits are identical in the second group, containing Bit 4, Bit 5, Bit 6, and Bit 7, and the first group is larger than the A-Register's corresponding first group value, then the value of the second (current) group's R1-Carry signal will be adjusted to the level of the first group's high logic level (=1) R1-Carry signal. If none of the previously explained condition is present, the adjustment will not produce the modification and the value of R1-Carry GRP 4-7 will remain the same. However the signal name change must occur similarly as it is explained for the first group in Drawing 720 and the adjusted “new” signal name will be TR-R1-Carry GRP 4-7.

FIG. 7B also includes two drawings of the Transfer circuits. Drawing 760 contains the third group's signals for group 8-11. The R2-Carry GRP 8-11 signal is connected to AND gate 761 and also connected to AND gate 762. The R2-Carry GRP 4-7 signal is connected to AND gate 761. The R1-Carry GRP 0-3 signal is connected to AND gate 761. The output of the AND gate 761 is connected to the OR gate 763. The R1-Carry GRP 4-7 signal is connected to AND gate 762. The output of the AND gate 762 is connected to the OR gate 763. The R1-Carry GRP 8-11 signal is connected to the OR gate 763. The output of the OR gate 763 is the adjusted value of the third (current) group's Rule 1 Carry signal, with the signal name of TR-R1-Carry GRP 8-11.

Drawing 780 contains the forth group's signals for group 12-15. The R2-Carry GRP 12-15 signal is connected to AND gate 781, AND gate 782 and also connected to AND gate 783. The R2-Carry GRP 8-11 signal is connected to AND gate 781 and also connected to AND gate 782. The R2-Carry GRP 4-7 signal is connected to AND gate 781. The R1-Carry GRP 0-3 signal is connected to the AND gate 781. The output of the AND gate 781 is connected to the OR gate 784. The R1-Carry GRP 4-7 signal is connected to the AND gate 782. The output of the AND gate 782 is connected to the OR gate 784. The R1-Carry GRP 8-11 signal is connected to the AND gate 783. The output of the AND gate 783 is connected to the OR gate 784. The R1-Carry GRP 12-15 signal is connected to the OR gate 784. The output of the OR gate 784 is the adjusted “new” value of the fourth (current) group's Rule 1 Carry signal, with the signal name of TR-R1-Carry GRP 12-15. Similarly for the previous adjustment circuits; if none of the adjustable condition is present, the adjustment will not produce any modification; however the signal name change must occur similarly as it is explained for the first group in Drawing 720 and the adjusted “new” signal name will be TR-R1-Carry GRP 12-15.

What is claimed is:

1. An OSBS Subtractor Accelerator comprising:
a combinational electronic circuit for enhancing the performance of a computer's Central Processing Unit, including:
a High Magnitude Detector Module, for comparing and indicating which of the input operand's group has higher absolute value and;
a Rule 1 Carry Transfer Circuit which sets the correct carry signal levels to all Bits of the identical groups of the input operands and;
a Carry Generator and Carry Selector Module for generating and selecting the final carry signals for all sets of the input operands and;
a Carry Look Ahead Merging Module, which is enabling the Carry Look Ahead Adder circuit to be used as a Carry Look Subtractor circuit, and;
a Mirroring Adapter Module for subtracting either input operand from the other.

2. The OSBS Subtractor Accelerator according to claim 1, wherein the Carry Generator and Selector Module comprises:
a Carry generator circuit, which generates the final Carry signals and;
a Carry selector circuit, which selects which final Carry signal is to be forwarded to the next Bit for completing the subtraction operation.

3. The OSBS Subtractor Accelerator according to claim 1, wherein the Carry Look Ahead Merging Module enables the Pure Carry Look Ahead Adder Circuit to be used as a Pure Carry Look Ahead Subtractor circuit by selecting the corresponding carry signals.

4. The OSBS Subtractor Accelerator according to claim 1, wherein the Mirroring Adapter Module is eliminating the needs for duplicating the Carry Generator and Carry Selector circuitry by subtracting a higher magnitude input operand from a smaller magnitude input operand, or subtracting a smaller magnitude input operand from a higher magnitude input operand.

5. The OSBS Subtractor Accelerator according to claim 1, wherein the circuit can operate in two different formats:
a Stand alone or Pure format and;
a Grouped format.

6. The OSBS Subtractor Accelerator according to claim 5, wherein for the Stand alone or Pure format the Carry Generator and Carry Selector Module is utilized.

7. The OSBS Subtractor Accelerator according to claim 5, wherein for the Grouped format three modules; the High Magnitude Detector Module, the Rule 1 Transfer Circuit and the Carry Generator and Carry Selector Module are utilized.

8. The OSBS Subtractor Accelerator according to claim 5, wherein the input operands divided into groups and the size of the groups are variable and all groups are operating simultaneously.

9. The OSBS Subtractor Accelerator according to claim 5, wherein the two input operands divided into groups; the required time to perform a simultaneous Rule 1 Carry Transfer operation for all groups is two propagation delays.

10. The OSBS Subtractor Accelerator according to claim 5, wherein every Bit comprises a Carry Generator and Carry Selector Module, and all Bits are operating simultaneously, and the required time for generating and selecting the final Carry signals for a subtractor circuit is two propagation delays.
